(19) United States
(12) Patent Application Publication
(10) Pub. No.: US 2014/0365713 A1
(43) Pub. Date: Dec. 11, 2014

(54) ELECTRONIC SYSTEM AND OPERATING METHOD THEREOF

(71) Applicant: Chao-Yu Chien, New Taipei City (TW)

(72) Inventor: Chao-Yu Chien, New Taipei City (TW)

(73) Assignee: ASMedia Technology Inc., New Taipei City (TW)

(21) Appl. No.: 14/295,332

(22) Filed: Jun. 4, 2014

(30) Foreign Application Priority Data
Jun. 7, 2013 (CN) 201310226397.1

(51) Int. Cl. G06F 3/06

(52) U.S. Cl. CPC G06F 3/0611; G06F 3/0679; G06F 3/0655
USPC 711/103

(57) ABSTRACT

An electronic system and an operating method thereof are provided. When a computer host is booting up and an external storage device is connected with the computer host, the BIOS of the computer host may read the parameter information recorded in a memory of a bridge unit via a bridge unit of the external device and displays the parameter information without initializing the storage unit and reading the parameter information from a magnetic region of the storage unit.

### CROSS-REFERENCE TO RELATED APPLICATION

This application claims the priority benefit of China application serial No. 201310226397.1, filed on Jun. 7, 2013. The entirety of the above-mentioned patent application is hereby incorporated by reference herein and made a part of specification.

### BACKGROUND OF THE INVENTION

1. Field of the Invention

The invention relates to an electronic system and, more particularly, to an electronic system with an external storage device and an operating method thereof.

2. Description of the Related Art

A hard disk (HDD) with a large capacity requires a long period to spin up to ready for being accessed during initializing. The initializing time of the HDD is usually longer than a time for a Basic Input/output System (BIOS) driver of the computer. Therefore, when a computer host is booting and is connected with the HDD via a universal serial bus (USB) bridge unit, most BIOS drivers cannot detect the USB HDD (especially the large capacity HDD or the HDD with low spin up speed), and the computer host cannot display the parameter information recorded in the magnetic region of the hard disk (such as a vendor name and a product model) during booting period. Accordingly, the computer host cannot use the HDD to boot up via the traditional USB bridge unit.

### BRIEF SUMMARY OF THE INVENTION

An electronic system and an operating method thereof are provided. When a computer host is booting up and connecting to an external storage device, the BIOS of the host detects and reads the parameter information (a HDD parameter data) that recorded in a memory of the external device and displays the parameter information.

The operating method of the electronic system is disclosed. The electronic system includes a host and an external storage device. The external storage device includes a storage unit, a memory, and a bridge unit. The storage unit is detachably connected with the external storage device. The magnetic region of the storage unit records parameter information related to the storage unit. The memory records the parameter information related to the storage unit. The operating method of the electronic system includes: the BIOS quickly detects and reads the parameter information recorded in the memory of the external storage device, and the bridge unit directly providing the parameter information in the memory to the host when the host is booting and is connecting to the external storage device.

An electronic system, a host, and an external storage device are provided. The external storage device includes a storage unit, a memory, and a bridge unit. The storage unit s detachably connected with the external storage device, wherein a magnetic region of the storage unit records parameter information related to the storage unit. The memory records the parameter information related to the storage unit. The bridge unit is electrically connected between the storage unit and the host. The BIOS quickly detects and reads the parameter information recorded in the memory of the external storage device, the bridge unit directly provides the parameter information in the memory to the host, and the BIOS displays the parameter information when the host booting up and connected with the external storage device.

These and other features, aspects and advantages of the present invention will become better understood with regard to the following description, appended claims, and accompanying drawings.

### BRIEF DESCRIPTION OF THE DRAWINGS

FIG. 1 is a circuit block diagram showing an electronic system in an embodiment; and

FIG. 2 is a flow chart showing a quick checking operating method of a bridge unit of an external storage device in an embodiment.

### DETAILED DESCRIPTION OF THE EMBODIMENTS

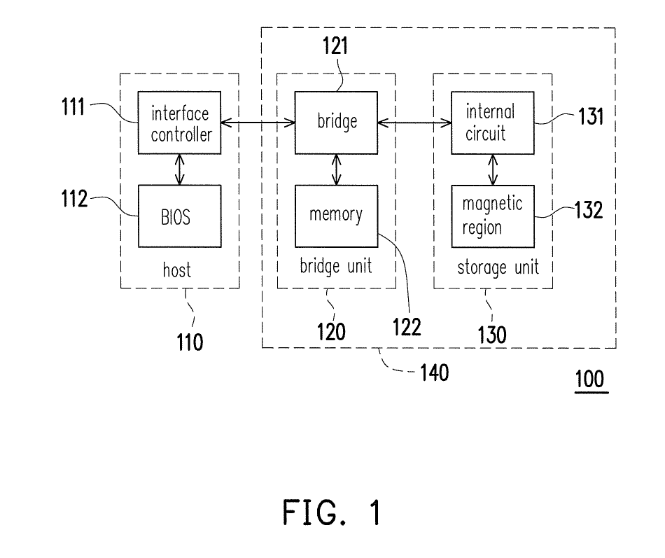

FIG. 1 is a circuit blocking diagram showing an electronic system 100 in an embodiment. The electronic system 100 includes a host 110 and an external storage device 140. The external storage device 140 includes a bridge unit 120, a storage unit 130. The bridge unit 120 includes a memory 122 and a bridge 121. The bridge 121 and the memory 122 are different chips in an embodiment in FIG. 1, wherein the memory 122 is electrically connected with the bridge 121. However, the implementation of the bridge unit 120 is not limited in FIG. 1. For example, the memory 122 may be an internal memory embedded in the bridge 121 in an embodiment. The memory 122 may be a non-volatile memory. For example, the memory 122 includes a serial peripheral interface flash memory.

The storage unit 130 is detachably connected with the external storage device 140. The storage unit 130 may be a data storage device in any type, such as a hard disk (HDD), a redundant array of independent disks (RAID), or other large capacity data storage devices. The storage unit 130 is the hard disk in the embodiment, which is not limited herein. The storage unit 130 includes an internal circuit 131 and at least one magnetic region 132. Parameter information related to the storage unit 130 is recorded in the magnetic region 132. The parameter information of the storage unit 130 includes a vendor identification (VID), a product identification (PID), a manufacture string, a length of the manufacture string, a product string, a length of the product string, a serial number, a length of the serial number, a HDD capacity, a HDD block size, and/or other related information of the storage unit 130.

The bridge 121 is electrically connected with the internal circuit 131 of the storage unit 130. For example, the bridge 121 may be electrically connected with the storage unit 130 via a serial advanced technology attachment (SATA) bus, an integrated drive electronics (IDE) bus, a universal serial bus (USB), or a thunderbolt bus. After the storage unit 130 is initialized (which includes that the magnetic region 132 spins up to a stable target rotate speed), the bridge 121 may access the magnetic region 132 via the internal circuit 131 of the storage unit 130. In general, during the hard disk is initialized, the storage unit 130 usually needs a long time to wait for the magnetic region 132 to spin up to get ready for being accessed. The initialization time of the hard disk from being powered on to ready is usually very long (such as a few seconds or tens of seconds). After waiting for that the storage unit 130 is ready, the bridge 121 can access the magnetic region 132, for example, the bridge 121 can read the parameter information of the storage unit 130 from the magnetic region 132.

The external storage device 100 may be electrically connected with the host 110 (such as a computer host). For example, the bridge 121 may be electrically connected with the host 110 via the USB or the thunderbolt bus. In the embodiment, the host 110 includes an interface controller 111 and a Basic Input/output System (BIOS) 112. The interface controller 111 may be a USB host controller, a thunderbolt controller, or other communication interface controllers. The BIOS 112 may communicate with an external device (such as the bridge unit 120) via the interface controller 111. The interface controller 111 is the USB host controller, and the storage unit 130 is a SATA hard disk in the following embodiment, which is not limited herein.

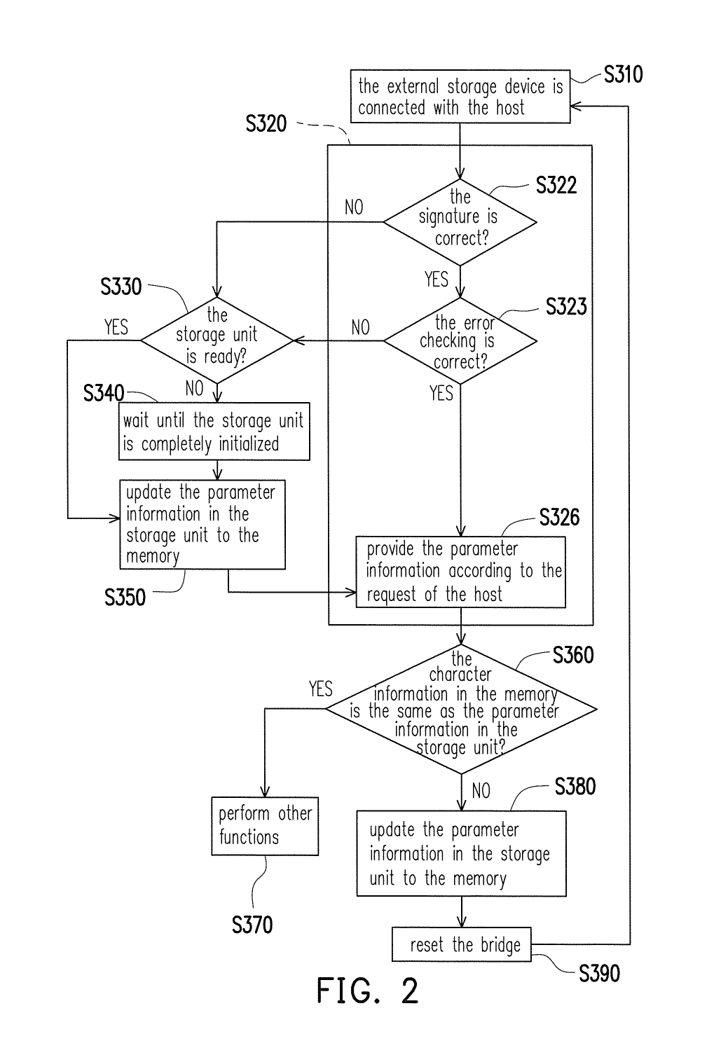

FIG. 2 is a flow chart showing a quick checking operating method of a bridge unit 120 of an external storage device 100. Please refer to FIG. 1 and FIG. 2.The external storage device 140 may be electrically connected with the host 110 in the step S310. In the embodiment, the storage unit 130 may be a hard disk, which can be replaced easily (for example, the hard disk with an A logo is replaced by a hard disk with a B logo). The parameter information related to the storage unit 130 is pre-recorded in the memory 122. When the host 110 is booting up and electrically connected with the external storage device 140, the BIOS 112 of the host 110 may send a request (a command) to access the data in the storage unit 130 of the external storage device 140. However, an initializing operation is executed between the host 110 and the external storage device 140 before the host 110 accesses the data. The host 110 requests to read the parameter information recorded in the storage unit 130 via the bridge unit 120, the bridge 121 may response the request of the host 10 and provide the parameter information recorded in the memory 122 to the host 110 (step S320), and then the parameter information is displayed on the host 110 via the BIOS 112, consequently, the host 110 can obtain the character of the current external storage device 140 via the parameter information, and the host 110 and the external storage device 140 can successfully finish the initializing operation.

The data structure of the parameter information recorded in the memory 122 can be determined according to the design requirement. Table 1 is the data structure of the parameter information in the memory 122 according to an embodiment of the invention, which is not limited herein.

TABLE 1
the data structure of the parameter information in the memory 122

| | bit | | | | | | | |
|---|---|---|---|---|---|---|---|---|
| byte | 7 | 6 | 5 | 4 | 3 | 2 | 1 | 0 |

| | |
|---|---|
| 0 | vendor identification (VID) |
| 1 | |
| 2 | product identification (PID) |
| 3 | |
| 4 | manufacture string |
| . . . | |
| 11 | |
| 12 | length of the manufacture string |
| 13 | product string |
| . . . | |
| 28 | |
| 29 | length of a product string |
| 30 | serial number |
| . . . | |
| 49 | |
| 50 | length of the serial number |
| 51 | HDD capacity |
| . . . | |
| 58 | |
| 59 | HDD block size |
| 60 | |
| 61 | signature |
| 62 | Checksum code |

Except for recording the parameter information of the storage unit 130, the memory 122 also may store other data or information according to the design requirement, for example, a firmware of the bridge 121 may be stored in the memory 122. The storing address of the memory 122 and the parameter information may be determined according to the design requirement.

In an embodiment, when the storage unit 130 and the bridge unit 120 are connected and powered on, the parameter information recorded in the magnetic region 132 of the storage unit 130 is firstly copied to the memory 122 to generate the parameter information recorded in the memory 122. Therefore, when the external storage device 140 is electrically connected with the host 110 again, the bridge 121 can quickly get and provide the parameter information related to the storage unit 130 from the memory 122 to the host 110 firstly before the storage unit 130 is ready.

When the host 110 is connected with the external storage device 140, the host 110 can request the bridge unit 120 to read the parameter information related to the storage unit 130 during the storage unit 130 is initialized. When the host 110 requests to read the parameter information recorded in the storage unit 130, since the storage unit does not finish initializing (the magnetic region 132 of the hard disk does not spin up to the stable rotate speed),the external storage device may provide the parameter information recorded in the memory 122 of the bridge unit 120 according to the request of the host 110, and furthermore, the parameter information is provided to the BIOS 112 of the host 110 to be displayed (step S320). Therefore, the BIOS 112 may instantly detect and obtain the parameter information of the storage unit 130 of the USB external storage device 140 during the host 110 boots up, and displays the parameter information related to the storage unit 130 (such as a vendor name and a product model). As a result, the host 110 may use the storage unit 130 to boot up via the bridge unit 120 of the external storage device 140, for example, an operating system (OS) is uploaded from the storage unit 130.

In the embodiment, in step S320, whether the parameter information recorded in the memory 122 is effective may be checked. If the parameter information in the memory 122 is ineffective (for example, the parameter information is damaged or blank), only after the storage unit 130 is completely initialized, the bridge unit 120 may read the parameter information from the magnetic region of the storage unit 130 and update it to the memory 122. For example, when it determines that the parameter information in the memory 122 is ineffective in the step S320, the bridge 121 may determine whether the storage unit 130 is completely initialized in the step S330. If the storage unit 130 is not completely initialized, the bridge 121 should wait until the storage unit 130 is completely initialized (step S340). When the storage unit 130 is completely initialized, the bridge 121 performs the step S350 to read the parameter information from the magnetic region 132 of the storage unit 130 and update (or copy) the parameter information recorded in the magnetic region 132 to the memory 122. After the step S350, the bridge unit 120 can provide the parameter information recorded in the memory 122 to the host 110.

The mode that the bridge 121 checks whether the parameter information in the memory 122 is effective in step S320 can be achieved in different ways. For example, in an embodiment, the step S320 includes sub-steps S322 to S326. The bridge 121 preforms the step S322 to verify whether the signature of the parameter information in the memory 122 is effective. The method of verifying a signature in the step S322 may be that checking whether a signature is a default value (such as 0x5A). If the signature recorded in the memory 122 is the default value, the bridge 121 can perform the step S323. If the signature recorded in the memory 122 is the default value (for example, the signature is 0xFF, it represents that the parameter information in the memory 122 is blank), the bridge 121 performs the step S330 and S340 to wait until the storage unit 130 is completely initialized.

In the step S323, the bridge 121 may check whether the parameter information in the memory 122 has an error, for example, it may check the parameter information in the memory 122 via a checksum code of the memory 122. If the result of the error checking represents that the parameter information in the memory 122 is effective, the bridge 121 may perform the step S326. If the result of the error checking represents that the parameter information in the memory 122 is not effective, the bridge 121 performs the step S330 and S340 to wait for that the storage unit 130 is completely initialized.

The step S322 and S323 may check whether the parameter information recorded in the memory 122 is complete. When the result of the step S322 and S323 are “YES”, it represents that the parameter information recorded in the memory 122 is effective. Therefore, When the host 110 requests to read the parameter information recorded in the storage unit 130 of the external storage device 140 via the bridge unit 120 of the external storage device 140, the bridge 121 of the bridge unit 120 can provide the parameter information in the memory 122 of the bridge unit 120 to the host 110 according to the request of the host 110 (step S326).

When the host 110 is booting up and is connected with the external storage device 140, the bridge 121 may read the parameter information of the storage unit 130 from the magnetic region 132 of the storage unit 130, and read the parameter information from the memory 122 in the step S360. The bridge 121 may check whether the parameter information recorded in the memory 122 is the same as the parameter information recorded in the storage unit 130 in the step S360. If the checking result of the step S360 represents that the parameter information recorded in the memory 122 is the same as the parameter information recorded in the storage unit 130, the bridge 121 continues to perform other functions (step S370).

If the checking result of the step S360 represents that the parameter information recorded in the memory 122 is different from the parameter information recorded in the storage unit 130, the bridge 121 may update (or copy) the parameter information recorded in the storage unit 130 to the memory 122 (step S380) to make the parameter information recorded in the memory 122 the same as the parameter information recorded in the storage unit 130. After the step S380, the bridge 121 may reset an operation mode of a central processing unit (CPU) of the bridge unit 120 (step S390).

As a result, When the host 110 is electrically connected with the external storage device 140 again and requests to read the parameter information recorded in the storage unit 130,the bridge 121 can quickly get the parameter information related to the storage unit 130 from the memory 122 before the storage unit 130 is completely initialized, and provide the parameter information to the host 110 firstly, and then provide the parameter information to the BIOS 112 of the host 110 according to the request of the host.

Consequently, the BIOS 112 may instantly detect and obtain the parameter information of the storage unit 130 during the host 110 booting up, and display the parameter information related to the storage unit 130 (such as the vendor name and the product model). The host 110 also may use the storage unit 130 to boot via the bridge unit 120 of the external storage device 140, for example, an operating system (OS) is loaded from the storage unit 130.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An operating method of an electronic system, the electronic system includes a host and an external storage device, the external storage device includes a storage unit, a memory, and a bridge unit, the storage unit is detachably connected with the external storage device, a magnetic region of the storage unit records parameter information related to the storage unit, and the memory records parameter information related to the storage unit; the operating method comprising:
providing the parameter information recorded in the memory to the host by the bridge unit when the host is connected with the external storage device.

2. The operating method of the electronic system according to claim 1, further comprising:
determining whether to update the parameter information recorded in the storage unit to the memory by the bridge unit when the storage unit is connected with the external storage device and completely initialized.

3. The operating method of the electronic system according to claim 1, wherein the storage unit includes a hard disk.

4. The operating method of the electronic system according to claim 1, wherein the parameter information includes a vendor identification, a product identification, a manufacture string, a product string, a serial number, a hard disk capacity, a hard disk block size, a signature, and the checksum.

5. The operating method of the electronic system according to claim 1, wherein the bridge unit is electrically connected with the storage unit via a serial advanced technology attachment (SATA) bus, a small computer system attachment bus, an integrated drive electronics bus, a universal serial bus, or a thunderbolt bus.

6. The operating method of the electronic system according to claim 1, wherein the bridge unit is electrically connected with the host via a universal serial bus or a thunderbolt bus.

7. The operating method of the electronic system according to claim 1, wherein the memory includes a non-volatile memory.

8. The operating method of the electronic system according to claim 7, wherein the non-volatile memory includes a serial peripheral interface flash memory.

9. The operating method of the electronic system according to claim 1, further comprising:
Waiting until the storage unit is completely initialized when the parameter information of the memory is not effective, and then reading the parameter information from the storage unit and updating the parameter information to the memory by the bridge unit.

10. The operating method of the electronic system according to claim 1, further comprising:
Checking whether the parameter information recorded in the memory is the same as the parameter information recorded in the storage unit by the bridge unit when the host is connected with the external storage device; and
updating the parameter information recorded in the storage unit to the memory if the parameter information recorded in the memory is not the same as the parameter information recorded in the storage unit.

11. The operating method of the electronic system according to claim 10, further comprising:
resetting the bridge unit after updating the parameter information recorded in the storage unit to the memory.

12. An electronic system, comprising:
a host; and
an external storage device, wherein the external storage device includes:
a storage unit detachably connected with the external storage device, wherein a magnetic region of the storage unit records parameter information related to the storage unit; and
a bridge unit including a memory for recording parameter information related to the storage unit, and wherein the bridge unit is electrically connected between the storage unit and the host;
wherein the bridge unit provides the parameter information recorded in the memory to the host when the host is connected with the external storage device.

13. The electronic system according to claim 12, wherein the bridge unit determines whether to update the parameter information recorded in the storage unit to the memory when the storage unit is connected with the external storage device and completely initialized.

14. The electronic system according to claim 12, wherein the storage unit includes a hard disk.

15. The electronic system according to claim 12, wherein the parameter information includes a vendor identification, a product identification, a manufacture string, a product string, a serial number, a hard disk capacity, a hard disk block size, a signature, or a checksum.

16. The electronic system according to claim 12, wherein the bridge unit is electrically connected with the storage unit via a serial advanced technology attachment bus, a small computer system attachment bus, an integrated drive electronics bus, a universal serial bus, or a thunderbolt bus.

17. The electronic system according to claim 12, wherein the bridge unit is electrically connected with the host via a universal serial bus or a thunderbolt bus.

18. The electronic system according to claim 12, wherein the memory includes a non-volatile memory.

19. The electronic system according to claim 18, wherein the non-volatile memory includes a serial peripheral interface flash memory.

20. The electronic system according to claim 12, wherein when the parameter information of the memory is not effective, after the storage unit is completely initialized, the bridge unit reads the parameter information from the storage unit and updates the parameter information to the memory.

21. The electronic system according to claim 12, wherein when the host is connected with the external storage device, the bridge checks whether the parameter information recorded in the memory is the same as the parameter information recorded in the storage unit by the bridge unit; and if the parameter information recorded in the memory is not the same as the parameter information recorded in the storage unit, the parameter information recorded in the storage unit is updated to the memory.

22. The electronic system according to claim 21, wherein the bridge unit is reset after the parameter information recorded in the storage unit is updated to the memory.
